(19) United States
(12) Patent Application Publication
(10) Pub. No.: US 2015/0104279 A1
(43) Pub. Date: Apr. 16, 2015

(54) Wheeled cart for use with portable freestanding weight system

(71) Applicant: Gregory S. Kenton, Minnetrista, MN (US)

(72) Inventor: Gregory S. Kenton, Minnetrista, MN (US)

(21) Appl. No.: 14/510,680

(22) Filed: Oct. 9, 2014

Related U.S. Application Data
(60) Provisional application No. 61/889,385, filed on Oct. 10, 2013.

(51) Int. Cl. B62B 3/06; E04G 21/32

(52) U.S. Cl. CPC B62B 3/06; E04G 21/3214
USPC 414/460; 248/205.1; 414/812

(57) ABSTRACT

A wheeled cart and method for moving a constant force weight system to and from a roof-top surface. The wheeled cart comprises a handle for pushing and a handle for pulling the cart; a front lift plate and a rear lift plate; and a winch device connected to both the front lift plate and the rear lift plate. The weight system is attached to the wheeled cart by interconnecting an opposing pair of adapted edges of the weight system with the front and a rear lift plate of the wheeled cart. When the weight system is connected to the lift plates, the winch device is wound or unwound to lift or lower the weight system such that the cart can be moved while carrying the weight system.

### CROSS REFERENCE TO RELATED APPLICATION

The present application is based on and claims the benefit of U.S. provisional patent application Ser. No. 61/889,385, filed Oct. 10, 2013, the content of which is hereby incorporated by reference in its entirety.

### BACKGROUND OF THE INVENTION

Those working on the flat roof surface of taller buildings face the risk of falling off the roof while working with, or moving equipment, or when working along the edges of the roof top. Strong gusts of wind could also unexpectedly knock a standing worker off their feet, increasing the risk of falling off the edge of the roof.

As a required safety measure, workers are generally secured to or harnessed to a fixed position on the roof by a system of ropes, which allow the worker to safely move about the roof surface. Movable constant force posts are typically used on roof top surfaces. Such force posts are movable and not permanently secured to the roof top surface. However, such force posts require a large amount of weight to secure the force post in a stationary position and sufficient weight to counter balance a worker in the event of a fall. In order to arrest the fall and suspend the worker, the counter weight system must provide sufficient downward force on the post to counteract the force created by the falling worker.

Presently, there are two methods of moving the weights associated with holding the constant force post to the roof surface. The first system involves a constant force post and a weighted cart system. The worker is attached to a weighted cart. The cart can be moved when a worker needs to be repositioned on the roof surface. The cart also requires a large heavy claw for engaging the roof surface in addition to the weights on the cart. If a worker falls, the cart arrests the workers fall by penetrating the roof surface or roof substrate with the claw. The claw digs into the surface of the roof and latches on in order to hold the cart in position and arrest the fall of the worker. The claw typically drags up a portion of the roof substrate in preventing the worker from falling off the roof to the ground below. This cart system effectively digs in to and tears up the substrate of a roof top surface, which can require extensive and expensive repair.

The second method includes the use of a non-penetrating weight system. Such an assembly requires disassembling the weight system piece by piece, and moving each piece individually to a second position on a roof surface as the worker moves along the roof top surface. Moving the weight system piece by piece is time consuming and requires a significant amount of strength and endurance from the worker, and may even require multiple people to move the system. The exertion increases especially if the roof top surface is large, which may require re-positioning the weights multiple times in order to perform work along the entire roof top.

### SUMMARY OF THE INVENTION

An aspect of the present disclosure relates to a cart for moving a constant force weight system to or from one or more positions on a roof-top surface. The cart comprises a frame and a plurality of surface engaging wheels rotatably secured to the frame. A first handle is secured to a first position on the frame and is configured for pushing the cart while a second handle is secured to a second location different from the first location and is configured for pulling the cart. Front and rear lift plates are secured to an underside of the frame and a winch device operably connected to both the front lift plate and the rear lift plate. An attachable weight system comprising a plurality of weights is arranged on a base and the winch device is configured to raise or lower the weight system when the weight system is attached to the cart and the winch device is wound or unwound such that the cart is configured to move the weight system.

Another aspect of the present disclosure also relates to a constant force weight system device for holding at least one layer of weighted plates comprising a substantially flat base configured to receive at least one layer of weighted plates and a plurality of upturned edges around the perimeter of the base. At least two of the plurality of upturned edges being further adapted with a downturned edge and a first and second hook extending from the center of the base allow the base and at least one layer of weighted plates to be moveable as single unit.

Another aspect of the present disclosure relates to a constant force weight system device for holding at least one layer of weighted plates comprising a ring having a first integral arm extending therefrom and a second integral arm extending therefrom, the arms extending from opposing sides of the ring. The device further comprises a down-turned edge on the distal end of each arm and a center opening within the ring. Apertures are positioned in the ring, the apertures adapted for insertion of fasteners and the device is secured on top of the at least one layer of weighted plates to hold the weights together as a single movable piece.

Yet another aspect of the present disclosure also relates to a method for repositioning a constant force weight system. The method comprises attaching the weight system to a wheeled cart via an opposing pair of adapted edges of the weight system interconnecting with a front and a rear lift plate of the wheeled cart and lifting the weight system off a surface by using a winch device attached to the wheeled cart. The cart is then pushed or pulled thus repositioning the weight system to a selected location. Using the winch device to lower the weight system to engagement with a surface of the selected location and disconnecting the adapted edges from the lift plates sets the weight in the selected location places the system in the selected location.

### BRIEF DESCRIPTION OF THE DRAWINGS

FIG. 1 is a side perspective view of a cart according to the present invention.

FIG. 2 is a front view of the cart.

FIG. 3 is a side perspective view of the cart with a weight system attached.

FIG. 4 is a rear perspective view of the cart with the weight system attached.

FIG. 5a is a side view of a base weldment according to the present invention.

FIG. 5b is a top view of the base weldment.

FIG. 6 is a perspective view of the weight system secured with a saddle.

FIG. 7 is an exploded view of the weight system with the saddle and a constant force post.

### DETAILED DESCRIPTION OF THE INVENTION

In one aspect, the present disclosure describes a free standing system of weighted plates, a constant force post and a wheeled cart. The system of weighted plates is assembled and secured to either a saddle or a base weldment. The wheeled cart can be used to hold and/or move the system of weighted plates to a selected position on a roof top surface. The cart is mobile across multiple positions on a roof top surface and once the system of weighted plates are in proximity to the selected location, the cart can be disengaged from the weight system and moved away from the weight system when the force post is in use.

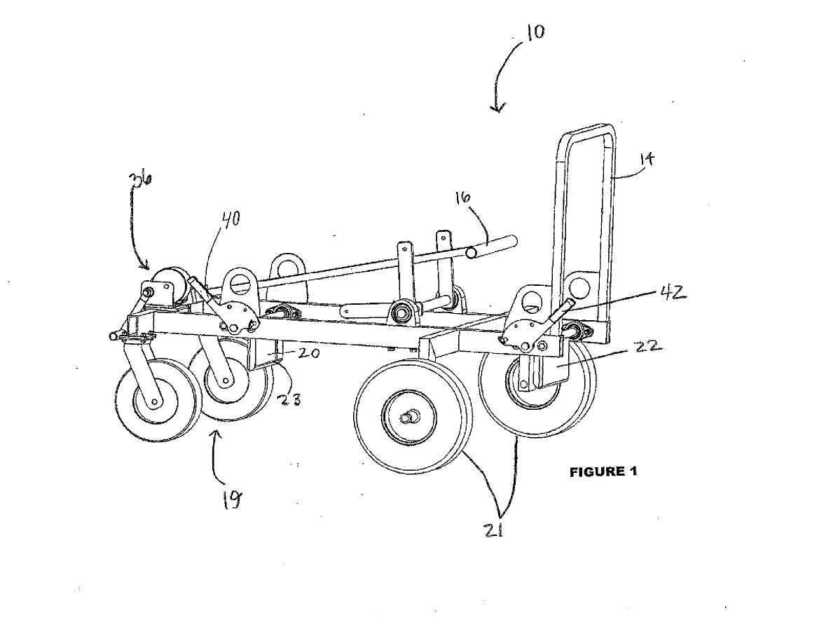

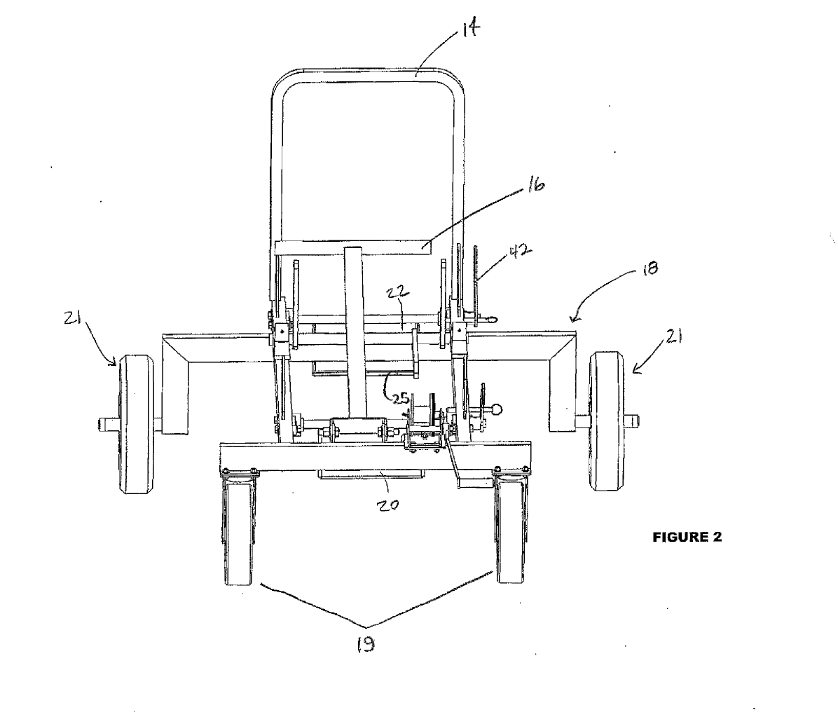

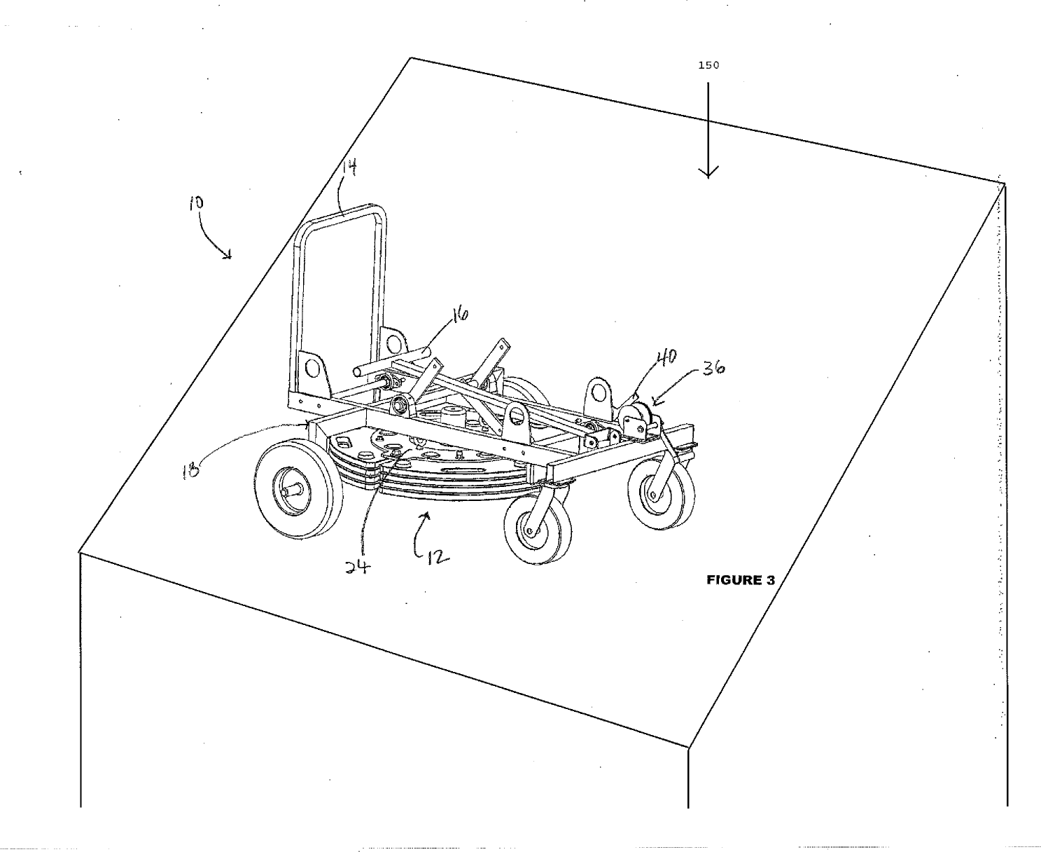

As illustrated in FIGS. 1-4, a wheeled cart 10 can be used to move a weight system 12 as well as can be used to store the weight system 12. As generally illustrated in FIGS. 1 and 2, the wheeled cart 10 comprises a handle 14 and an additional pull bar 16 allowing the cart to be pushed or pulled when repositioning or moving the cart with or without the weight system 12 attached to the cart 10. The pull bar 16 is pivotable about its connection to the cart and rotatable such that the bar 16 can be positioned over the body of the cart 10, or extended away from the cart 10 for use. The cart frame 18 is secured to a connection with a front set of wheels 19 and a rear set of wheels 21. The cart frame 18 is positioned on top of, or above the wheels, creating an open space. The open space below the cart frame 18 and bounded by the front set of wheels 19 and rear set of wheels 21. The weight system 12 may then be connected to the frame 18 and freely lifted or lowered within the open space.

The cart frame 18 is further adapted with a front lift plate 20 and a rear lift plate 22. The lift plates 20 and 22 are comprised of steel or another durable material and are substantially flat plates with a slight upwardly bent bottom length 23 and 25. The lift plates 20 and 22 are connected to a winch device 36 by a rope or a chain such that the winch device can be wound to let out or pull in the rope or chain and thus lower or lift the plates 20 and 22. The lift plates 20 and 22 attach to the weight system 12 by connection with a saddle 24 or a base weldment 26. Levers 40 and 42, which are secured to the cart frame 18 proximate each lift plate 20 and 22 allow a user to move the lift plates 20 and 22 into and out of connection with the weight system 12 as described in more detail further below.

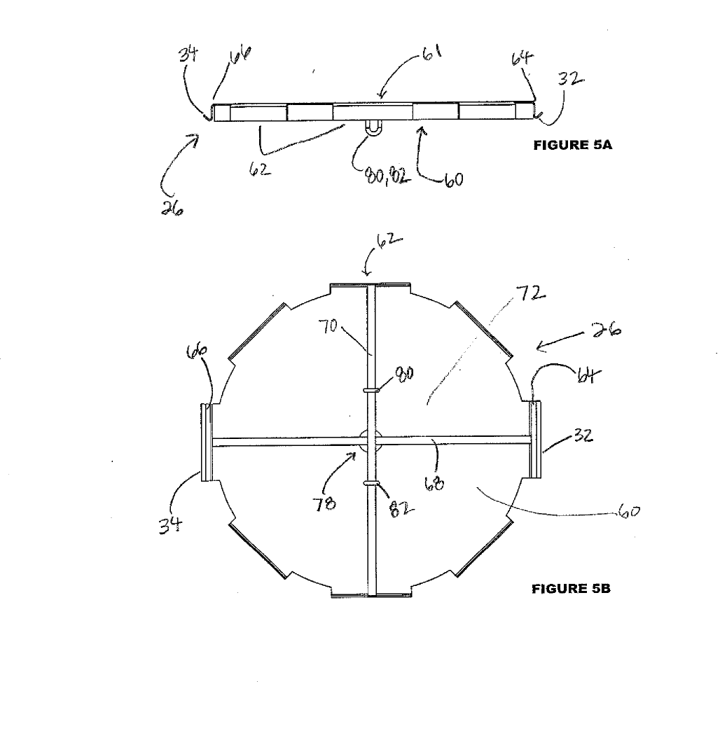

As illustrated in FIGS. 2-6, and described in more detail below, the lift plates 20 and 22 attach to the saddle 24 by catching and hooking the underside of a down turned edge 28 and 30 of an arm on the saddle 24. The lift plates 20 and 22 can be detached from the saddle by disengaging the lift plates 20 and 22 from the down turned edges 28 and 30. The lift plates 20 and 22 engage with the base weldment 26 illustrated in FIGS. 5a and 5b, in a substantially similar way. The lift plates 20 and 22 can also engage with the down turned edges 32 and 34 of the base weldment 26 by a hooking connection of bottom portions 23 and 25. Once the lift plates 20 and 22 are secured in connection with the down turned edges 28 and 30 or 32 and 34 the winch device 36 can be cranked by a handle 38. The winch device 36 is connected to each lift plate 20 and 22 and used to raise or lower the lift plates 20 and 22 with respect to the cart frame 18 and in turn to raise and/or lower the attached weight system 12.

The lift plates 20 and 22 when connected to the saddle 24 or the base weldment 26 allow the weight system 12 to be raised or lowered with minimal input or exertion by a user. The weight system 12 is also raised or lowered while being held in one piece, and moved while in a substantially level position. The weight system 12 does not need to be disassembled to be raised and moved from one position to another position and can be moved easily by a single user without undue exertion.

In further detail, the weight system 12 can be moved into a raised position, the weight system 12 being lifted off and cleared from the roof top surface 150 and out of contact with the roof substrate. When lifted or raised, the weight system 12 is solely supported by the lift plates 20 and 22, the winch system 36 and thus the wheeled cart 10. When raised, the lift plates are locked in place by the securing the handle of winch device in a locked position. This allows a user to push or pull the wheeled cart 10 to a desired position on a roof top surface 150 or any other surface in which the weight system 12 is to be placed. When the weight system 12 has been moved to a desired position, the weight system 12 is lowered to rest on the desired surface. The winch 36 is used to lower the plates 20 and 22 and the attached weight system 12 until the weight system 12 rests on and is in contact with the roof top surface 150 or substrate, or another selected surface. The lift plates 20 and 22 can then be easily disconnected from the weight system 12.

Once the weight system 12 has been set into a desired position, the wheeled cart 10 can be disconnected from the weight system 12 and wheeled away, allowing the weight system 12 to be freely accessed and in which a user can attach themselves to via a rope or other harness.

The cart 10 can be brought back and positioned over the weight system 12 to reattach to, and move, the weight system 12 to a second position. The cart is reconnected by connecting the lift plates 20 and 22 to the system 12. The winch 36 can then be used to raise the weight system. The cart 10 supporting the weighted plates can then be moved to another position with minimal effort by the user as the user will only need to push or pull the cart 10.

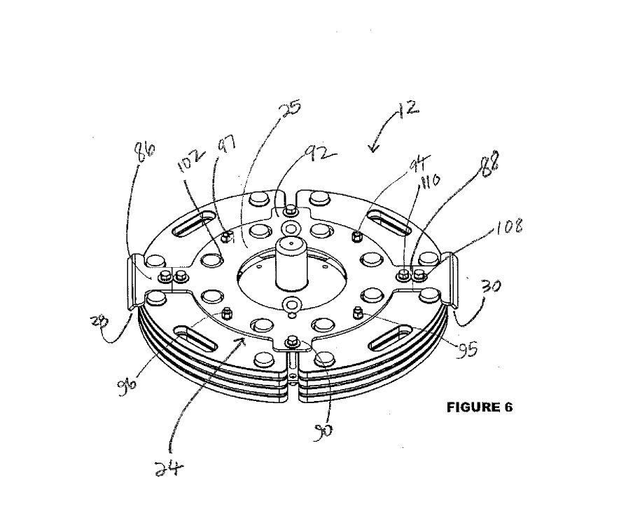

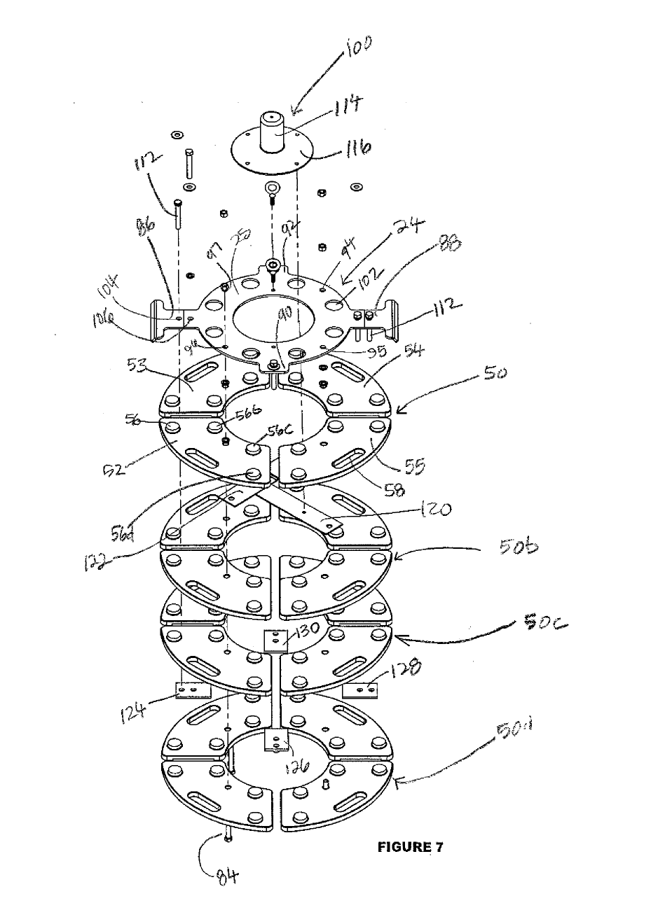

As further illustrated in FIGS. 6 and 7, the weight system 12 comprises at least a first layer 50 comprising multiple weighted plates 52, 53, 54, 56. Subsequent layers 50b, 50c, 50d of weighted plates are assembled in substantially the same manner as the first layer 50. Each of the plates 52, 53, 54, 56 forming a layer 50 is substantially of the same construction. In the example illustrated, layer 50 is comprised of four (4) weighted plates 52, 53, 54, 55. The individual weighted plates 52, 53, 54, 55 are comprised of aluminum, steel or another material suitable for use as a weight. Each plate 52, 53, 54, 55 is shaped substantially as a quarter section of a circumference or flat ring. The plates 52, 53, 54, 55 are shaped such that when four plates are placed side by side the plates form a substantially closed ring while still allowing at least a small open space between each side edge of adjacent plates and a center aperture. The plates 52, 53, 54, 55 are substantially flat and smooth, and each plate 52, 53, 54, 55 has an opening or cut out 58 in the center of the outer edge, to provide a space that may be used as a handle to move the individual plates 52, 53, 54, 55. Each plate is also adapted with at least one protrusion 56, the protrusion 56 and each additional protrusion 56b, 56c, 56d being substantially circular in shape. Each protrusion can be positioned proximate one of the corners on a top surface of the plate and thus a bottom surface of a plate in a subsequent layer. The protrusions are used to provide a space between layers of weighted plates when stacked. The protrusions may also be used to hold the plates 52, 53, 54, 55 in connection with the saddle 24.

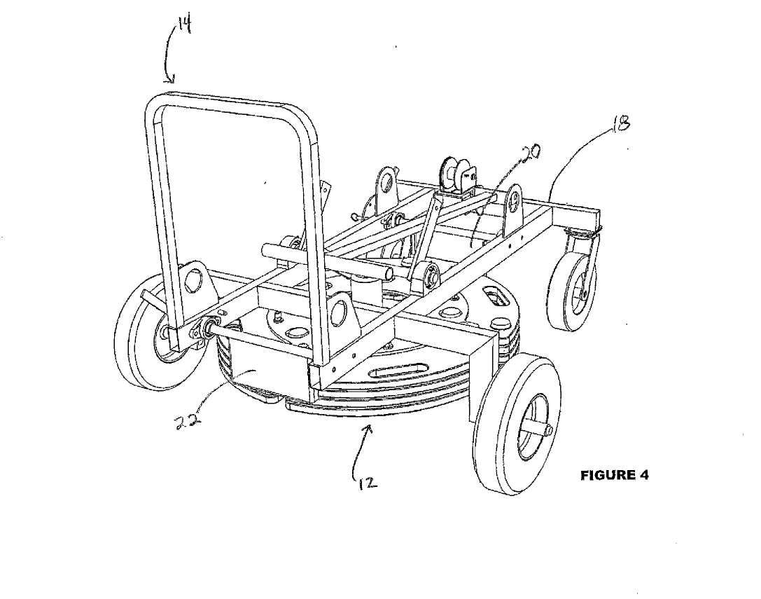

As further illustrated in FIG. 5, in one embodiment, each layer 50, 50b, 50c, 50d of weighted plates can be secured in the base weldment 26 to form the weight system 12. The base weldment 26 is a substantially round, flat, rubber coated base 60. The base weldment 26 can be made of steel, aluminum or another suitable material of sufficient strength, weight and durability. The weldment 26 can be coated with rubber, or the bottom surface otherwise textured, in order to provide increased friction between a bottom surface 61 of the base weldment 26 and a top surface of a roof or roof substrate or any surface on which the base 26 is to set upon. The rubber or rubber like coating also protects the base weldment 26 and provides a surface for preventing the plates 52, 53, 54, 55 from sliding or moving when placed in the base weldment 26. The rubber coated base also prevents sliding or moving of the plates 52, 53, 54, 55 when the weight system 12 is being moved by the wheeled cart 10. The base weldment 26 is of sufficient thickness to support multiple layers 50, 50b, 50c, 50d of weighted plates, but not so thick as to be immovable. For example, as illustrated in FIG. 4, the thickness of the base weldment 26 walls is approximately 7 gauge.

The weldment 26 has upturned edge portions 62 along the circumferential perimeter. The upturned edges 62 are upturned at approximately 90 degrees from the base and are substantially straight and rigid along an arcuate length of the circumference of the base of the weldment 26. The upturned edges 62 provide support for the layers 50, 50b, 50c, and 50d of weighted plates by preventing the individual weighted plates from sliding off or out of the weldment 26. The upturned edges 62 are of sufficient height to provide a perimeter to the weldment 26. Two upturned edges 64 and 66, on opposing sides of the weldment 26, have been adapted further with a down turned edge 32 and 34, respectively. The down turned edges 32 and 34 extend outwardly from the upturned edges and away from the base at an angle approximately 90 degrees or less from the upturned edge, creating a hook area or ledge. The weldment 26 is also quartered by two sections of tubing 68 and 70 secured or welded to the base, prior to application of the rubber coating, on the top surface 72 of the weldment 26. The tubing 68 and 70 is of a sufficient height to provide support and strength to the base and to contain at least a first layer 50 of weighted plates on the base weldment 26. For example, in one embodiment, the tubing 68 and 70 is 1-inch wide by 2-inch high steel tubing. The first section 68 lies across a first diameter of the weldment 26. The second section of tubing 70 lies across a second diameter of the weldment 26 so that the sections cross in the center 78 of the weldment 26.

A first down-loop 80 and a second down-loop 82 extend outwardly and upwardly from the top surface 72 of the weldment 26. The down-loops 80 and 82 are positioned along the second section of tubing 70, near the center of the base 78, but each down-loop 80 and 82 is positioned on an opposite side of the first section of tubing 68. The loops 80 and 82 may be used to secure a rope wherein the rope is also secured to a worker.

A first layer 50 of weighted plates 52, 53, 54, and 55 is set in the base 26. Multiple layers 50b, 50c and 50d may then be stacked and secured to and on top of the first layer 50 in the base weldment 26. The layers 50, 50b, 50c, and 50d of weighted plates can be secured together in the base 26 for added stability to the weight system 12. The layers 50, 50b, 50c and 50d may be secured by a fastener 84 and clamping mechanism between auxiliary clamping plates 124, 126, 128 and 130 and a second set of auxiliary plates (which can be of substantially the same construction as plates 124, 126, 128 and 130). The clamping plates 124, 126, 128 and 130 being placed under a bottom layer 50b, 50c or 50d with a second set of substantially identical plates positioned on top of the top layer 50 of weighted plates can secure the weighted plates and thus the layers. The clamping mechanism which secures the layers 50, 50b, 50c and 50d of weighted plates together comprises aligning a bottom clamping plate 124, 126, 128 and 130 with a top clamping plate (not shown) and aligning the apertures of each plate. Multiple fasteners 84 would then be inserted through one weighted plates into connection with the second weighted plates such that when fastened, the fasteners 84 clamp the layers 50, 50b, 50c and 50d of weighted plates between two clamping plates. The fasteners then occupy the space between adjacent weighted plates 52 and 53, 54, and 55 in the layers 50, 50b, 50c, and 50d.

Once assembled with the desired amount of weight, the amount sufficient with regard to the user or the height of the roof top surface, the weight system 12 comprised of the base weldment 26 can be used with the cart 10 as described above.

An alternative embodiment is illustrated in FIGS. 6 and 7. The weight system 12 may be assembled with the saddle 24. When the saddle 24 is used, the weight system 12 is effective when a user is connected to a constant force post 100 used with the weight system 12.

The saddle 24 is generally comprised of a disk with a center opening such that the saddle is substantially a ring 25 with two arms 86 and 88 extending integrally from two opposing sides of the ring 25. The ring 25 is also adapted on two opposing sides, opposite the arms 86 and 88 with two extensions 90 and 92 extending integrally from the ring 25. The arms 86 and 88 extend from the ring 25 substantially further than the extensions 90 and 92.

As illustrated in FIG. 7 the saddle 24 is generally flat and smooth, and for example is comprised of approximately ⅜ inch thick steel, or another suitable material providing stability and durability. In the center of the ring 25 is an aperture providing a space sufficient for the constant force post 100 to be positioned and secured within. The width of the ring 25 is sufficient for providing a support surface, and support for the weight system 12 when multiple layers 50, 50b, 50c, and 50d are added to the system 12. The ring 25 is adapted with apertures 94, 95, 96 and 97 around the circumference of the ring 25 to receive and support a retaining rod and/or fastener 84. The ring 25 is also adapted with openings 102 around the circumference of the ring 25, the openings 102 are slightly larger than a corresponding protrusion 56 on the weighted plates 52, 53, 54, and 55. At least one protrusion 56 aligns with an opening 102 in the ring 25 and fits within the opening to hold the weighted plates 52, 53, 54, and 55 in position and to prevent the weighted plates 52, 53, 54, and 55 from sliding out of position.

The arms 86 and 88 extend from the ring 25 wherein the distal end of each arm 86 and 88 comprises a smooth down-turned curved end 28 and 30. The down-turned end 28 and 30 being of a height sufficient to allow the down-turned ends to be used to connect the saddle to the lift plates 20 and 22 of the cart 10.

The arms 86 and 88 are adapted with two adjacent apertures 104, 106, 108, and 110 along the length of and substantially in the center of the arm 86 and 88. The apertures 104, 106, 108 and 110 are adapted to receive a fastener or holding pin 112.

The extensions 90 and 92 are adapted with apertures for a fastener 112 near the center of the extension 90 and 92 such that a fastener 112 would fit in the space between the edges of two adjacent plates 52, 53, 54, and 55 in a layer of plates 50, 50b, 50c, and 50d as outlined further below. The extensions 90 and 92 have a depth from the ring 25 and a width sufficient to contact two adjacent plates 52, 53, 54, and 55 and to provide a clamping connection with the plates 52, 53, 54, and 55 when a fastener 112 is used.

The first layer 50 of weighted plates is secured to the saddle 24 with the layer 50 aligned substantially with the ring 25 of the saddle 24 and having a space between the sides of each adjacent weighted plates, the space large enough to accommodate a retaining bar there through. The layer 50 of weighted plates fits in the space including the ring 25 and the arms 86 and 88. The saddle 24 can accommodate the addition of one or more layers 50b, 50c, and 50d, up to at least 4 layers of weighted plates.

Positioned in the center of the ring 25 of saddle 24 is the constant force post 100. The constant force post 100 comprises a generally cylindrical tube 114 integrally extending outwardly and upwardly from the center of a substantially flat disk 116. The distal end of the tube 114 is adapted with a loop-hook 118 or other suitable connector to which a rope may be secured by hook or suitable clamp. The post 100 is comprised of steel, aluminum or another suitable material of sufficient strength. The post 100 is then secured to the weight system 12 by connection of the disk 116 to two substantially flat auxiliary sections of steel 120 and 122 or another suitable metal, which are inserted between a first layer 50 of weighted plates and a second layer 50, 50b, 50c or 50d of weighted plates. Each flat section 120 and 122 is adapted with apertures for insertion of a fastener 84. The fastener 84 is inserted through an aperture in an outer end portion of each section 120 and 122 and an inner end portion of the section 120 and 122. The fastener 84 then extends through to apertures in the disk 116. When fastened, the post 100 is secured to the weight system 12 by clamping connection of the disk 116 and the auxiliary sections 120 and 122.

The layers 50, 50b, 50c, and 50d of weighted plates are secured together in the weight system 12. When the saddle 24 is part of the weight system 12, the layers are secured by a fastener and clamping mechanism between the arms 86 and 88 and the extensions 90 and 92 and plates 124, 126, 128 and 130. The saddle 24 is positioned on the top of the first layer 50 of weighted plates and subsequent layers 50b, 50c, and 50d of weighted plates are added or stacked below the first layer 50 of weighted plates. The clamping mechanism which secures the layers 50, 50b, 50c and 50d of weighted plates together comprises placing the clamping plates 124, 126, 128 and 130 below the lowest or bottom layer of weighted plates and aligning the apertures with the apertures in the arms 86 and 88 and extensions 90 and 92. The fasteners 112 then occupy the space between adjacent weighted plates 52, 53, 54, and 55 in the layers 50, 50b, 50c, and 50d and extend and connect the clamping plates 124, 126, 128 and 130 with the saddle 24, thus the securing the layers 50, 50b, 50c, and 50d together.

When either the saddle or the base weldment is used, the addition of layers of weighted plates may be proportional to the height of the building and/or to the weight of the worker securing themselves to the base weldment or to the constant force post 100 used with the saddle. Use of the base weldment 26 can eliminate the need for use of the saddle 24. The base weldment 26 can be used with the cart 10 in substantially the same fashion as the saddle 24 described previously.

Further, additional weight systems may be used and positioned along the length of or along different positions of a roof top surface. The weight systems 12 would be connected and connected to a user by a rope or other suitable method. Thus multiple weight systems may be linked together for various benefits, including additional support for workers or when the roof top surface is at an extreme height or when conditions are windy. Additional layers of weighted plates can and should be added as the height of the roof from the ground increases or the weight of the worker attached to the constant force post increases.

Although the present invention has been described with reference to preferred embodiments, workers skilled in the art will recognize that changes may be made in form and detail without departing from the spirit and scope of the invention.

What is claimed is:

1. A cart for moving a constant force weight system for use on a roof top surface, the cart comprising:
a frame;
a plurality of surface engaging wheels rotatably secured to the frame;
a first handle secured to a first position on the frame and for pushing the cart;
a second handle secured to a second location different from the first location and for pulling the cart,
a front lift plate and a rear lift plate secured to an underside of the frame;
a winch device operably connected to both the front lift plate and the rear lift plate;
an attachable weight system comprising a plurality of weights arranged on a base; and
wherein the winch device is configured to raise or lower the weight system when the weight system is attached to the cart and the winch device is wound or unwound such that the cart is configured to move the weight system.

2. The cart of claim 1 wherein the second handle is movable between a first position extending outwardly from the cart for use and a second position over the cart for storage.

3. The cart of claim 1 wherein the frame is secured to the first and second set of wheels where the frame is set above the wheels providing an open space below the frame.

4. The cart of claim 3 wherein the cart further comprises the frame being secured substantially on top of the set of wheels and the weight system being attached below the frame.

5. The cart of claim 1 where in the frame further comprises a front cross bar for attachment of the winch.

6. The cart of claim 1 wherein the base comprises a ring in which individual weighted plates are secured thereto.

7. A constant force weight system device for holding at least one layer of weighted plates comprising:
a substantially flat base configured to receive at least one layer of weighted plates;
a plurality of upturned edges around the perimeter of the base;
at least two of the plurality of upturned edges being further adapted with a down turned edge;
a first and second hook extending from the center of the base; and
wherein the base and at least one layer of weighted plates are moveable as single unit.

8. The device of claim 8 wherein the base is a disk.

9. The device of claim 7 wherein a first bar extends across a first diameter of a top surface of the disk and a second bar extends across a second diameter of the top surface of the disk such that the bars cross at a mid-point of the disk.

10. The device of claim 8 wherein the device is made of steel.

11. The device of claim 10 wherein the device is rubber coated.

12. A constant force weight system device for holding at least one layer of weighted plates, the device comprising:
a ring having a first integral arm extending therefrom and a second integral arm extending therefrom, the arms extending from opposing sides of the ring;
a down-turned edge on the distal end of each arm;
a center opening within the ring;
apertures positioned in the ring, the apertures adapted for insertion of fasteners; and
wherein the device is secured on top of the at least one layer of weighted plates to hold the weights together as a single movable piece.

13. The device of claim 12 wherein the ring further comprising a first tab and a second tab, the tabs integral and extending from opposing sides of the ring and the tabs being adjacent to each arm.

14. The device of claim 13 wherein the tabs are each adapted with an aperture configured for further securing the at least one layer of weighted plates to the ring.

15. The device of claim 14 wherein the device is connected to a wheeled cart by interconnection of the down-turned edge on the distal end of each arm for moving the device from a first location to a second location.

16. The device of claim 12 wherein the at least one layer of weighted plates comprises a plurality of individual weighted plates arranged in a circular layer.

17. The device of claim 12 wherein a constant force post is positioned within the center ring and secured to the device by interconnection with the at least one layer of weighted plates.

18. A method for moving a constant force weight system the method comprising:
attaching the weight system to a wheeled cart via an opposing pair of adapted edges of the weight system interconnecting with a front and a rear lift plate of the wheeled cart;
lifting the weight system off a surface by using a winch device attached to the wheeled cart; and
pushing or pulling the cart and the attached weight system to a selected location for placement of the weight system at the selected location.

19. The method of claim 18 and further including the step of lowering the weight system by using the winch device and disconnecting the adapted edges from the lift plates to set the weight system on a surface of the selected location.
